(19) United States
(12) Patent Application Publication
(10) Pub. No.: US 2007/0101374 A1
(43) Pub. Date: May 3, 2007

(54) System and method for providing enhanced video programming to a user

(75) Inventors: Mark Sherman, Montreal (CA); Ian MacLean, Beaconsfield (CA)

Correspondence Address: MERCHANT & GOULD PC, P.O. BOX 2903, MINNEAPOLIS, MN, 55402-0903, US

(73) Assignee: ETC. TV INC., Montreal (CA)

(21) Appl. No.: 11/264,776

(22) Filed: Oct. 31, 2005

(51) Int. Cl. H04N 7/173; H04N 5/445; G06F 3/00; G06F 13/00

(52) U.S. Cl. 725/86; 725/45; 725/87; 725/61

(57) ABSTRACT

A system for providing extended video programming to at least one user, includes a remote management unit including an encoder for encoding into a short form advertisement a code related to the extended video programming. The short form advertisement is subsequently distributed by an MSO to a network of receivers. The receivers receive and decode the stream received from the MSO and display a visual indication that said extended video programming is available when said short form advertisement is displayed on a screen. The receiver is adapted to bookmark the enhanced video programming, view the enhanced video programming and do nothing. The system also includes a client residing at the receiver for collecting information relating to actions taken by the users with the receivers in regard to said extended video programming and for transmitting the same to a reporting module.

### FIELD OF THE INVENTION

The present invention relates to a system and method for providing enhanced video programming to a user.

### DESCRIPTION OF THE PRIOR ART

Digital video and television broadcasts are well known in the art. In such broadcasts, it is typical to also broadcast short advertisements, generally no longer than 60 seconds, in segments of 3 to 4 minutes during the regular programming.

Users, or viewers, are more and more bypassing these advertisements, since the advertisements are not always relevant to the user. This is done, for example by using personal video recorders (PVRs), where the users record the regular programming and then view it, without the advertisements, at a subsequent time.

However, at one time or another, a user may be interested in a product or service that is advertised, but would like more in depth information than a 30- or 60-second clip. Thus, enhanced video programming, or long form advertisements have been developed. These are typically broadcast presently as “infomercials”, usually at low viewing hours, or on dedicated channels.

There has, in response to this desire by viewers, been developed systems and methods to provide interactive services for digital television, such as the one disclosed in U.S. Patent Application No. 2002/0013942-A1 to Kim. In this system, background commercials (i.e. enhanced video programming), is broadcast at the same time as the regular programming, and the system is adapted to permit the user to view or save the background commercial. The system to Kim is further geared to providing incentives to the user to view the background commercials.

One of the disadvantages of the Kim system is that the background commercial is broadcast at the same time as the regular programming, which considerably increases the bandwidth required for the transmission of the regular programming. Also, should the user wish to save the background commercial for later viewing, the same is stored on the user's receiver, which takes up space that would otherwise be used for regular programming storage.

Another approach which has been taken is to provide each MSO (Multiple Service Operator) at the MSO head-end with the necessary hardware and software to provide interactive television services. Such a system is described in U.S. Patent Application No. 2003/0126611-A1 to Chernock et al. One of the disadvantages of such a system is that multiple MSOs cannot share the same equipment. Another disadvantage is that advertisers cannot control an advertisement campaign from a single or central location.

### SUMMARY OF THE INVENTION

It is an object of the present invention to provide a system and method for providing enhanced video programming to a user, where bandwidth of the regular programming is not affected, and where delivery and tracking of the enhanced video programming is centrally effected.

In accordance with an aspect of the invention, there is provided a system for providing extended video programming to at least one user, comprising:

a remote management unit including an encoder for encoding into a short form advertisement a code related to said extended video programming, said short form advertisement being subsequently distributed by at least one MSO to a network of receivers associated with said MSO in a stream;

a server for storing said extended video programming associated with said code;

at least one receiver for receiving and decoding said stream, said receiver, upon receipt of said stream containing said short form advertisement and said code, displaying a visual indication that said extended video programming is available when said short form advertisement is displayed on a screen;

said receiver being further adapted, upon user selection, to:
(a) index said extended video programming by sending to said MSO information relating to indexing of said enhanced video programming and to said extended video programming for subsequent viewing by said user; or
(b) display said extended video programming by retrieving said extended video programming from said server; or
(c) do nothing; and
   a client residing at said receiver for collecting information relating to actions taken by said users with said receivers in regard to said extended video programming and for transmitting the same to a reporting module.

In another aspect of the invention, there is provided a method for providing extended video programming to at least one user, comprising:

providing said extended video programming and storing said extended video programming on a server;

providing a short form advertisement;

encoding into said short form advertisement a code related to said extended video programming;

delivering said short form advertisement with said code in a stream to at least one MSO, each MSO having a network of receivers;

displaying a visual indication that said extended video programming is available when said short form advertisement is displayed on a screen by said receiver;

upon user selection, indexing said enhanced video programming for later viewing; recording said enhanced video programming at a later time; displaying said enhanced video programming; or doing nothing; or a combination thereof;

collecting information relating to actions taken by said users with said receivers in regard to said extended video programming and transmitting the same to a reporting module.

Yet another aspect of the invention provides a method for managing the delivery of extended video programming to a plurality of receivers associated with a respective MSO, said method comprising:

(a) providing said enhanced video programming to at least one MSO remotely selected;

(b) providing a short form advertisement to a broadcaster associated with said at least one MSO, said short form advertisement including a code related to said enhanced video programming;

(c) displaying a visual indication that said enhanced video programming is available for viewing with said receiver.

Still another aspect of the invention provides a remote management unit for controlling at least one advertisement campaign, said remote management unit including an encoder for encoding into a short form advertisement a code relating to an enhanced video programming; said remote management unit being in communication with a plurality of MSOs; said remote management unit, through a campaign manager, remotely selecting at least one MSO and transmitting said enhanced video to said at least one selected MSO for storage thereat and sending to at least one broadcaster said short form advertisement, wherein when said short form advertisement is received at receivers associated with said at least one selected MSO, a visual indication that said enhanced video programming is available for viewing.

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of the various components in which the present invention finds application;

FIG. 2 is a screen shot of a short-form advertisement;

FIG. 3 is a screen shot of the displaying of an icon;

FIG. 4 is a screen shot of the options available to a user in a cable, telephony or wireless video-on-demand context;

FIG. 5 is a screen shot of an enhanced video programming;

FIG. 6 is a representation of a digital code; and

FIG. 7 is a representation of a code.

### DESCRIPTION OF A PREFERRED EMBODIMENT OF THE INVENTION

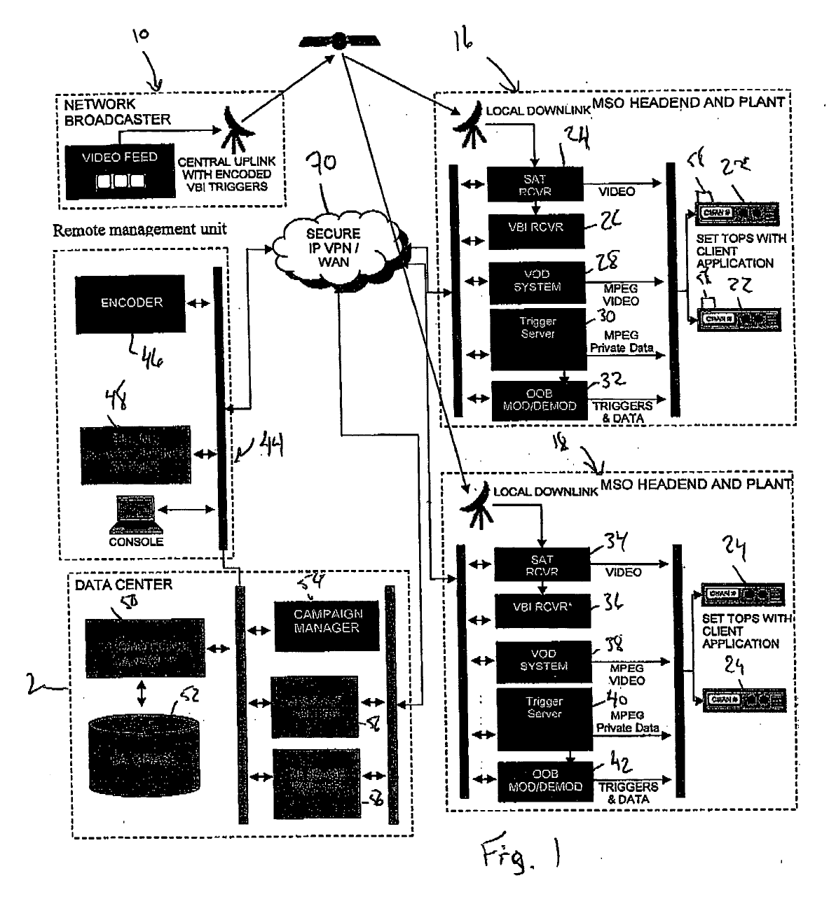

Referring now to FIG. 1, there is illustrated an environment in which the present invention finds application. The environment consists of a plurality of broadcasters 10, multiple service operators 16, 18 (it should be understood that at least one MSO is required but that there may be a plurality thereof, even though only two are illustrated) and receivers 22, 24. One MSO 16 controls receivers 22, and MSO 18 controls receivers 24. In the context of the present description, “controls” means that the receivers are legitimately registered with the appropriate MSO, and are programmed to decode the channels that the viewer or subscriber has paid for. The set of receivers that are controlled by the corresponding MSO forms a network. This is of course of particular use in digital television, whether delivered by cable or satellite, or by any other means. It will be understood that the present invention finds application in a video on demand environment, whether delivered by cable, telephone or wirelessly.

It will also be appreciated that presently, in order to have access to digital television, one must have a receiver, which takes the form of a set-top box (i.e. a separate unit). However, although they are not commercially available at this point, televisions which include the receiver will become available, and the present invention is not limited to set-top boxes.

As is well known, the various broadcasters 10 broadcast their programming, including short form advertisements, and the MSOs bundle the signals from a plurality of broadcasters and deliver the resulting stream to the corresponding receivers.

As mentioned previously, one of the aspects of the invention is to provide enhanced video programming to users. In this connection, an advertiser, say company A, prepares or has prepared a short form advertisement (as is presently being done). Company A also prepares or has prepared an enhanced video programming (viz. a long form advertisement).

The enhanced video programming is transmitted or sent to the MSO for storage on an MSO's server 28, 38. It will be noted here that the bandwidth of the original video stream is not affected by the presence of the enhanced video programming, one of the advantages of the present invention. The servers 28, 38 are known in the art, and are being used presently to deliver video-on-demand (VOD) services. Of course, it will be understood that although a server is described, it could be more than one, and in fact some MSOs mirror the information on a central server to distributed servers in the network.

In one aspect of the invention, the system has a remote management unit 44. The remote management unit, for reasons which will become apparent hereinafter, is preferably centrally located, although some elements may be decentralized. The remote management unit 44 is provided with an encoder 46 for encoding into the short form advertisement a code 60 which includes information relating to the enhanced video programming. The short form advertisement is then sent or transmitted to broadcaster 10, and eventually arrives at MSO 16 or 18 for delivery to a receiver 22, 24.

In a preferred embodiment of the invention, the code 60 that is placed in the short form advertisement is placed in the VBI (Vertical Blanking Interval). This is true in an analog world, which is the dominating technology presently in the area of television. However, as mentioned previously, as television sets become available which include the receivers, it is possible that television will switch to an all digital format, in which case the code would advantageously be delivered with the digital signal.

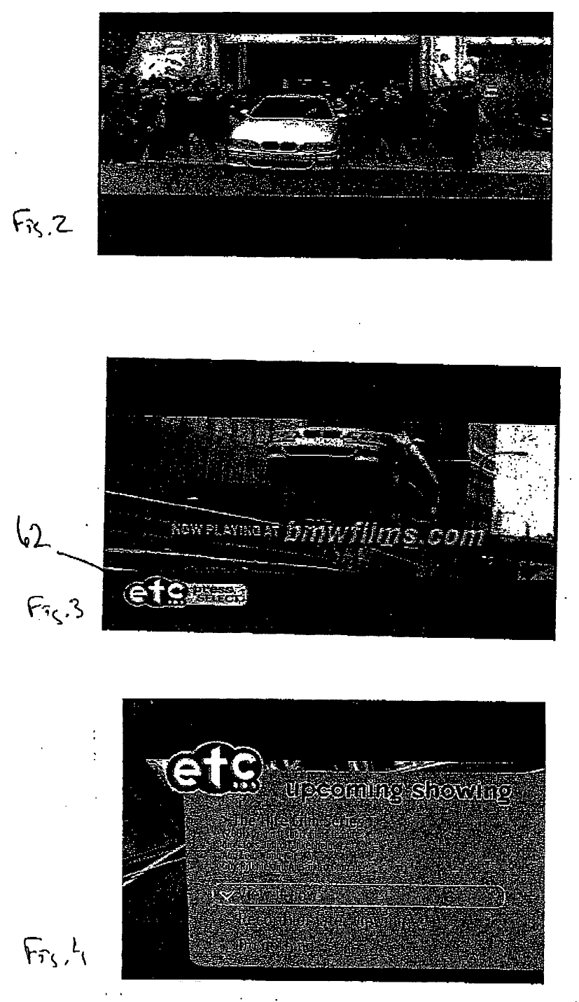

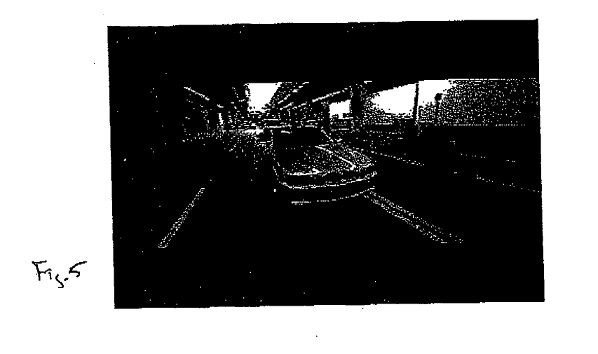

The receiver 22, 24 displays an icon 62 indicating to the user that enhanced video programming is available when said short form advertisement is received at said receiver 22, 24 (see for example FIG. 3). FIGS. 2-5 are screen shots of what appears on the screen of a user. Of course, a person skilled in the art will recognize that this icon 62 will only be displayed when a user is watching (in real time or time delayed) the channel that the advertisement is being broadcast on. Upon displaying of this icon 62, the user can bookmark the enhanced video programming, watch the enhanced video programming, or do nothing (see FIG. 4).

If the enhanced video programming is bookmarked, the receiver 22, 24 sends a signal to the database 52 back in data center indicating that the user of this particular receiver wants to bookmark the enhanced video programming. This information is stored on a server 52 at the data center. This provides the advantage of not storing any information locally on the receivers 22, 24. This information can be later retrieved by the user for subsequent viewing of the enhanced video programming.

If the user selects to view the enhanced video programming, the receiver 22, 24 uses the information contained in the code 62 to contact the server 28, 38 and obtain the enhanced video programming from the server 28, 38.

The user can also choose not to do anything, in which case the icon appears on the screen and then disappears once the short form advertising containing the code is finished.

A reporting module 58 is also provided, which is loaded as a client on each receiver 22, 24. The reporting module 58 is operatively connected to each MSO. The reporting module 58 tracks whether each enhanced video programming has been stored or viewed, which data can be further used by advertisers for profiling purposes. It will however be understood that the data is sufficiently generic to comply with Privacy Acts, or similar legislation, which have been enacted in various jurisdictions.

Now that the invention has been described in broad terms, a more detailed description follows.

Referring now to FIG. 1, there is shown remote management unit 44, MSOs 16 and 18 and broadcaster 10. It will be appreciated that MSOs and remote management unit are in communication with each other through a network 70, preferably secured, which can be a public switched telephone network, or the internet, or by a radio link or any other means.

Each MSO includes many components but only those that are relevant to the present invention will be discussed. Thus, each MSO 16, 18 has or is provided with a receiver 24 for receiving the signal from the broadcaster 10 (which can be a satellite signal or a cabled signal, or any other type). Each MSO also includes at least one server 28, 30 for storing the enhanced video programming and for storing the bookmark information referred to previously.

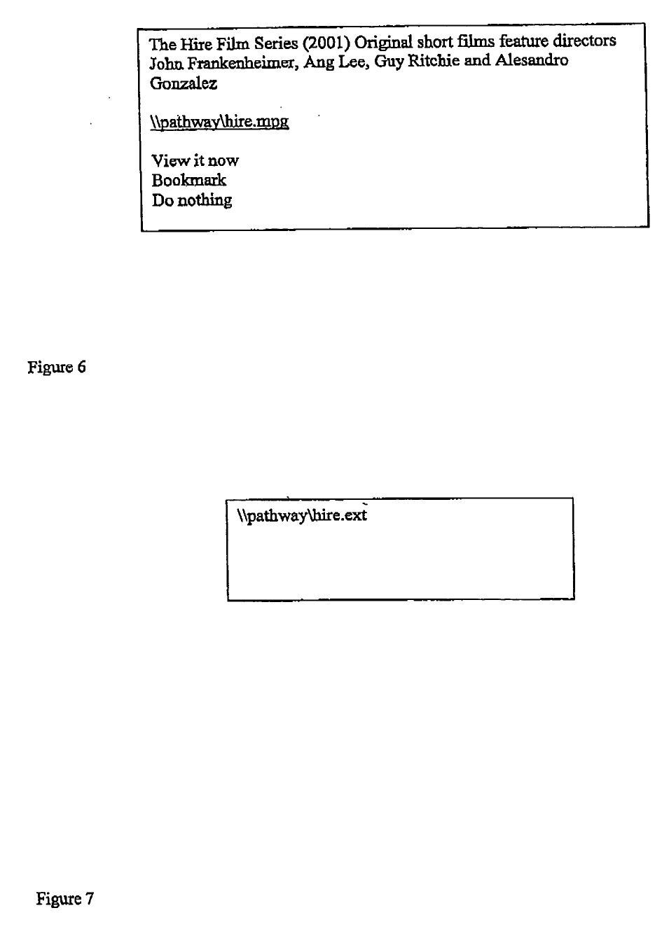

Presently, since broadcasters use mainly the analog video and the MSO operate in a digital word, the code 60 that is included in the short form advertisement must be extracted from the advertisement, and converted into a digital format, before the stream is sent to the receivers. Consequently, the MSO also include a decoder 26 for decoding the stream. The decoder 26 is adapted to receive the stream and “look” for the code 60 in the VBI. When a code 60 has been received, it is extracted and sent over the network 70 to the remote management unit 70 data center 72. The data center 72 unit converts the code 60 into a digital code 64. The digital code preferably includes the location of the enhanced video programming, some text associated with the enhanced video programming (i.e. a description thereof), and the three choices to present to the user: bookmark, view now or do nothing (see FIGS. 6 and 7). The digital code 64 is sent from the data center 72 back to the MSO to another server 30. This server sends to the receivers 22, 24 the digital code along with the stream. FIGS. 6 and 7 illustrate the type of information that may be contained in the code 60 and digital code 64, although it will be appreciated that different information may be included to meet the needs of various operators of the system of the present invention.

Then, the receiver 22, 24, when it receives the digital code 64, displays an icon indicating to the user that enhanced video programming is available (see FIG. 3). The user, using for example a remote control, would press a button such as the “select” button, which displays on the screen the text relating to the long form advertising, and presents the user with three choices: viewing now, bookmarking or do nothing (see FIG. 4).

Alternatively, if the short form advertisement is originally in digital format, the code does not need to be converted, and would include the necessary information which could be extracted at the MSO head-end, or by the receiver itself.

In order to provide reporting capabilities, a client program 58 is loaded into each receiver 22, 24. This client 58, or reporting module, keeps track of what goes on at the receiver 22, 24—which enhanced video programming has been watched, bookmarked, etc. This information is periodically sent back to the data center 72 to the promotions manager module 50. The promotions manager module 50 publishes the data to the campaign manager 54, which processes the data which is then exported to a billing system 48.

Another aspect of the invention concerns the remote management unit 44 which is in communication with a plurality of MSOs in a large geographic area through network 70. This enables central location to remotely select which MSO will receive the enhanced video programming, thereby enabling advertisers to centrally control ad campaigns. Thus, an advertiser can run a first campaign in, say Houston, which campaign is tailored to that particular market, and can run the same or different campaign in, say Montreal. Advertiser would then be billed and provided with profiling information on both campaigns at essentially the same time. This also enables advertiser to modify or adapt the campaign in view of the feedback provided.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for providing extended video programming to at least one user, comprising:
a remote management unit including an encoder for encoding into a short form advertisement a code related to said extended video programming, said short form advertisement being subsequently distributed by at least one MSO to a network of receivers associated with said MSO in a stream;
a server for storing said extended video programming associated with said code;
at least one receiver for receiving and decoding said stream, said receiver, upon receipt of said stream containing said short form advertisement and said code, displaying a visual indication that said extended video programming is available when said short form advertisement is displayed on a screen;
said receiver being further adapted, upon user selection, to:
(a) index said extended video programming by sending to said MSO information relating to indexing of said enhanced video programming and to said extended video programming for subsequent viewing by said user; or
(b) display said extended video programming by retrieving said extended video programming from said server; or
(c) do nothing; and
a client residing at said receiver for collecting information relating to actions taken by said users with said receivers in regard to said extended video programming and for transmitting the same to a reporting module.

2. A system according to claim 1, wherein said reporting module further includes a billing module.

3. A system according to claim 1, wherein said server is a video on demand server, each MSO having said video on demand server.

4. A system according to claim 1, wherein said remote management unit further includes a campaign manager for associating said short form advertisement with said extended video programming and for defining parameters of an advertisement campaign, said campaign manager being in communication with said server through a network.

5. A system according to claim 4, wherein said network is a secure network.

6. A system according to claim 1, wherein said remote management unit further includes an operator interface.

7. A system according to claim 1, wherein said information relating to indexing said enhanced video programming and to said enhanced video programming is stored by said MSO on a server.

8. A system according to claim 4, wherein said remote management unit is centrally located, whereby a plurality of campaigns across a plurality of MSOs can be managed from a single location.

9. A system according to claim 1, wherein said system further includes a decoder, located at an MSO head-end, for decoding said code in said short form advertisement, and for requesting a digital code corresponding to said code and wherein said system further includes a server for receiving said digital code and transmitting the same to all receivers associated with an MSO.

10. A system according to claim 9, wherein said digital code includes information about a location of said enhanced video programming, descriptive text relating to said enhanced video programming and text relating to the three choices presented to the user.

11. A system according to claim 1, wherein said billing module is located at said remote management unit.

12. A method for providing extended video programming to at least one user, comprising:
providing said extended video programming and storing said extended video programming on a server;
providing a short form advertisement;
encoding into said short form advertisement a code related to said extended video programming;
delivering said short form advertisement with said code in a stream to at least one MSO, each MSO having a network of receivers;
displaying a visual indication that said extended video programming is available when said short form advertisement is displayed on a screen by said receiver;
upon user selection, indexing said enhanced video programming for later viewing; recording said enhanced video programming at a later time; displaying said enhanced video programming; or doing nothing; or a combination thereof;
collecting information relating to actions taken by said users with said receivers in regard to said extended video programming and transmitting the same to a reporting module.

13. A method for managing the delivery of extended video programming to a plurality of receivers associated with a respective MSO, said method comprising:
(a) providing said enhanced video programming to at least one MSO remotely selected;
(b) providing a short form advertisement to a broadcaster associated with said at least one MSO, said short form advertisement including a code related to said enhanced video programming;
(c) displaying a visual indication that said enhanced video programming is available for viewing with said receiver.

14. A remote management unit for controlling at least one advertisement campaign, said remote management unit including an encoder for encoding into a short form advertisement a code relating to an enhanced video programming; said remote management unit being in communication with a plurality of MSOs; said remote management unit, through a campaign manager, remotely selecting at least one MSO and transmitting said enhanced video to said at least one selected MSO for storage thereat and sending to at least one broadcaster said short form advertisement, wherein when said short form advertisement is received at receivers associated with said at least one selected MSO, a visual indication that said enhanced video programming is available for viewing.

15. A remote management unit according to claim 14, wherein said unit is further adapted to receive said code from said at least one selected MSO and return a digital code to said at least one selected MSO.

16. A remote management unit according to claim 15, wherein said digital code includes text relating to said enhanced video programming.
